(19) United States
(12) Patent Application Publication
(10) Pub. No.: US 2013/0036334 A1
(43) Pub. Date: Feb. 7, 2013

(54) COMPUTING DEVICE AND METHOD FOR TESTING SERIAL ATTACHED SCSI PORTS OF SERVERS

(71) Applicants: HSIEN-CHUAN LIANG, Tu-Cheng (TW); SHEN-CHUN LI, Tu-Cheng (TW); SHOU-KUO HSU, Tu-Cheng (TW); JUI-HSIUNG HO, Tu-Cheng (TW); CHIEN-HUNG LIU, Tu-Cheng (TW); CHENG-HSIEN LEE, Tu-Cheng (TW)

(72) Inventors: HSIEN-CHUAN LIANG, Tu-Cheng (TW); SHEN-CHUN LI, Tu-Cheng (TW); SHOU-KUO HSU, Tu-Cheng (TW); JUI-HSIUNG HO, Tu-Cheng (TW); CHIEN-HUNG LIU, Tu-Cheng (TW); CHENG-HSIEN LEE, Tu-Cheng (TW)

(73) Assignee: HON HAI PRECISION INDUSTRY CO., LTD., Tu-Cheng (TW)

(21) Appl. No.: 13/479,299

(22) Filed: May 24, 2012

(30) Foreign Application Priority Data
Aug. 1, 2011 (TW) 100127278

(51) Int. Cl. G06F 11/00

(52) U.S. Cl. 714/100; 714/E11.02

(57) ABSTRACT

In a method for testing serial attached SCSI (SAS) ports of a server using a computing device, the computing device connects to an oscilloscope and a mechanical arm that is equipped with a test fixture having a probe. The mechanical arm controls the probe to be plugged into one of the SAS ports. The method adjusts an intensity grade of the SAS signals through the SAS port, and controls the SAS port to generate a SAS signal corresponding to the intensity grade. The test fixture obtains the SAS signal from the SAS port, and the oscilloscope measures test parameters of the SAS signal. The method analyzes values of the test parameters to find an optimal SAS signal, determines an intensity grade of the optimal SAS signal as a driving parameter of the SAS port, and accordingly generates a test report of the SAS ports.

### BACKGROUND

1. Technical Field

Embodiments of the present disclosure relate to systems and methods for testing ports of servers, and particularly to a computing device, a storage medium, and a method for testing serial attached small computer system interface (SCSI) ports (hereinafter “SAS ports”) of a server.

2. Description of Related Art

Many or most servers need fast access to their data. As such, hard disk drives with fast seek time is desired. One such hard disk drive is the Serial attached SCSI (SAS) hard disk drive. The SAS hard disk drives connect to a processor of the server through one or more SAS ports. Each of the SAS hard disk drives may generate SAS signals when data is exchanged between the SAS hard disk drive and the processor, and then the SAS signals are transmitted to the processor through the SAS ports. Usually, the SAS signals may be measured to evaluate whether each of the SAS ports is workable. However, such test operation are usually performed manually, and is time consuming. Also, the efficiency and accuracy of the test operation cannot be ensured.

### BRIEF DESCRIPTION OF THE DRAWINGS

FIG. 1 is a block diagram of one embodiment of a computing device including an SAS port testing system.

FIG. 2 is a flowchart of one embodiment of a method for testing SAS ports of an server using the computing device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as an EPROM. The modules described herein may be implemented as either software and/or hardware modules and may be stored in any type of non-transitory computer-readable medium or other storage device. Some non-limiting examples of non-transitory computer-readable medium include CDs, DVDs, flash memory, and hard disk drives.

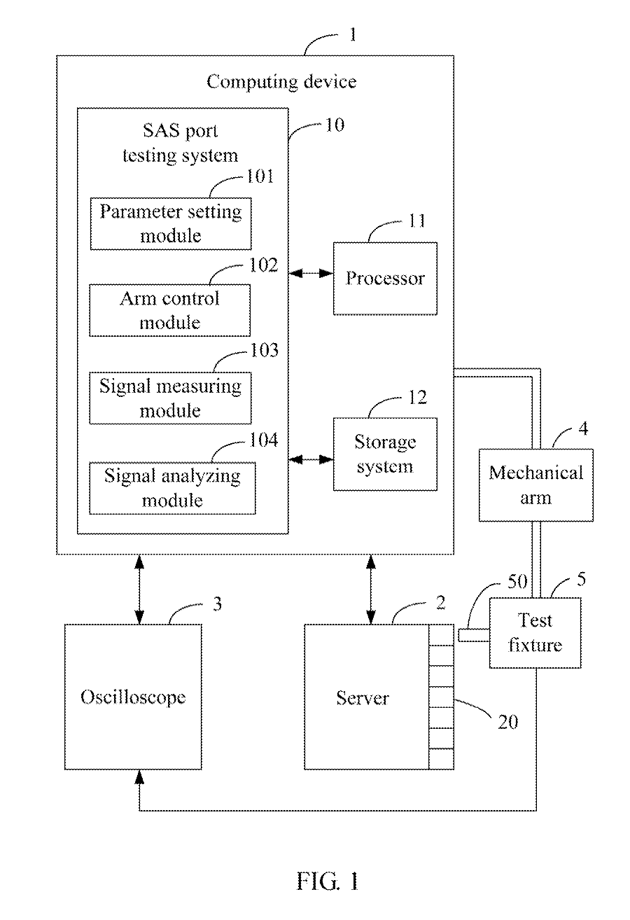

FIG. 1 is a block diagram of one embodiment of a computing device 1 including a serial attached SCSI port (hereinafter “SAS port”) testing system 10. In the embodiment, the computing device 1 may further include at least one processor 11 and a storage system 12. The computing device 1 connects to a server 2 through a serial port such as a COM port, and connects to an oscilloscope 3 through a first general purpose interface bus (GPIB). The computing device 1 further connects to a mechanical arm 4 that is equipped with a test fixture 5. The test fixture 5 connects to the oscilloscope 3 through a second GPIB.

In one embodiment, the server 2 is a computer or a data processing device that includes a plurality of SAS ports 20. Each of the SAS ports 20 transmits one or more SAS signals to the computing device 1 through the serial port. The oscilloscope 3 measures a plurality of test parameters from a SAS signal transmitted from each of the SAS ports 20. In one embodiment, the test parameters may include a phase value, a jitter value, a period value, a frequency value, a rising time and a falling time of the SAS signal.

The SAS port testing system 10 may include a plurality of functional modules that are stored in the storage system 12 and executed by the at least one processor 11. In one embodiment, the storage system 12 may be an internal storage system, such as a random access memory (RAM) for temporary storage of information, and/or a read only memory (ROM) for permanent storage of information. The storage system 12 may also be an external storage system, such as an external hard disk, a storage card, or a data storage medium.

In one embodiment, the SAS signal analysis system 10 includes a parameter setting module 101, an arm control module 102, a signal measuring module 103, and a signal analyzing module 104. The modules 101-104 may comprise computerized instructions in the form of one or more programs that are stored in the storage system 12 and executed by the at least one processor 11. A detailed description of each module will be given in the following paragraphs.

The parameter setting module 101 sets a group of test parameters for evaluating integrity of the SAS signals, and sets an intensity grade of the SAS signals and a total number (denoted as “X”) for testing the SAS ports 20. In one embodiment, the intensity grade of the SAS signals includes a phase grade, a jitter grade, and a signal emphasis grade of the SAS signal. If each intensity grade is defined as a grade range from one grade to three grades, the total number may be set as X=3*3*3=9 times. If each intensity grade is defined as a grade range from one grade to five grades, the total number may be set as X=5*5*5=125 times.

The arm control module 102 controls a probe 50 of the test fixture 5 to be plugged into each of the SAS ports 20 of the server 2 using the mechanical arm 4. In the embodiment, the arm control module 102 generates a command to drive the mechanical arm 4 to control the probe 50 of the test fixture 5 to be plugged into one of the SAS ports 20 to be tested.

The signal measuring module 103 adjusts the intensity grade of the SAS signals through each of the SAS ports 20, and controls each of the SAS ports 20 to generate a SAS signal corresponding to the intensity grade. The signal measuring module 103 further obtains the SAS signal generated by the SAS ports 20 using the test fixture 5, and measures a value of the test parameter of the SAS signal using the oscilloscope 3. In one embodiment, the signal measuring module 102 enhances the SAS signal by increasing the intensity grade of the SAS signal, and weakens the SAS signal by decreasing the intensity grade of the SAS signal.

The signal measuring module 103 further records the values of the test parameters into a predefined file, such as an EXECL format file, and stores the predefined file into the storage system 12. The signal measuring module 103 increases a test number (denoted as “Y”) by one, i.e., Y=Y+1, when the values of the test parameters are recorded into the predefined file, and determines whether the test number is equal to the total number.

The signal analyzing module 104 analyzes the values of the test parameters to find an optimal SAS signal when the test number is equal to the total number. In the embodiment, the optimal SAS signal has a minimum jitter value or a minimum phase value. The signal analyzing module 103 further determines an intensity grade of the optimal SAS signal as a driving parameter of the SAS port 20, generates a test report of the SAS ports 20 according to the values of the test parameters, and stores the test report of the SAS ports 20 into the storage system 12.

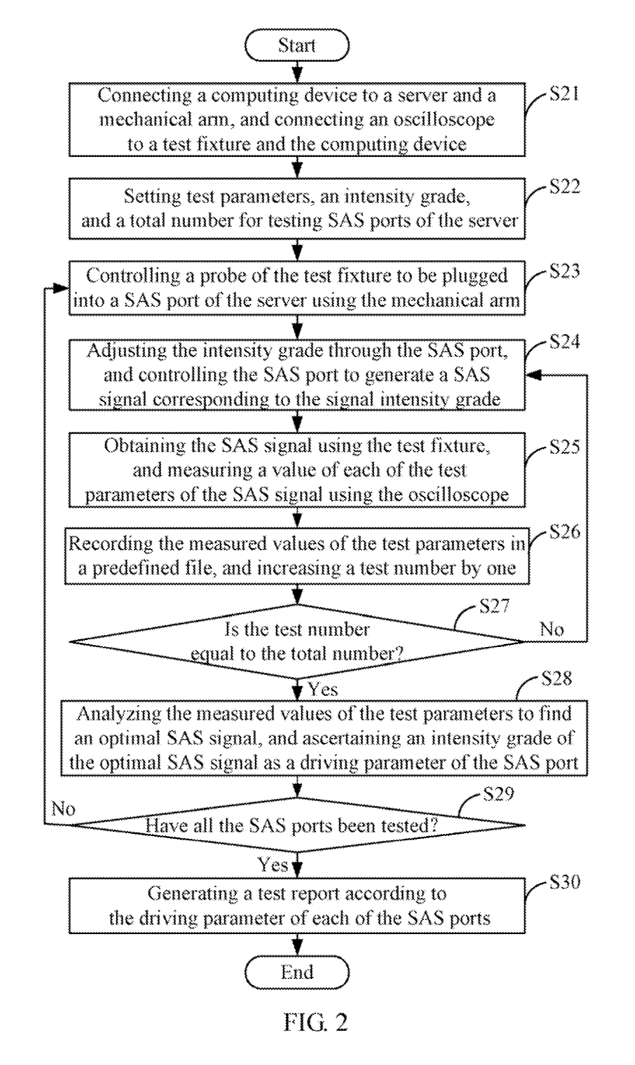

FIG. 2 is a flowchart of one embodiment of a method for testing SAS ports 20 of the server 2 using the computing device 1 of FIG. 1. In the embodiment, the method can obtain one or more SAS signals transmitted from each of the SAS ports 20 to test each of the SAS ports 20, and determines a driving parameter for each of the SAS ports 20 according to the test results. Depending on the embodiment, additional steps may be added, others removed, and the ordering of the steps may be changed.

In step S21, the test operator connects the computing device 1 to the server 2 and the mechanical arm 4, and connects the oscilloscope 3 to the computing device 1 and the test fixture 5. In the embodiment, the computing device 1 connects to the server 2 through the serial port, connects to the oscilloscope 3 through the first GPIB. The mechanical arm 4 is equipped with the test fixture 5. The test fixture 5 connects to the oscilloscope 3 through the second GPIB.

In step S22, the parameter setting module 101 sets a group of test parameters for evaluating SAS signals, an intensity grade of the SAS signals, and a total number (denoted as “X”) for testing the SAS ports 20. In one embodiment, the test parameters may include a phase value, a jitter value, a period value, a frequency value, a rising time and a falling time of each of the SAS signals. The intensity grade of the SAS signals includes a phase grade, a jitter grade, and a signal emphasis grade of the SAS signal. If each of the intensity grades is defined as a grade range from one grade to three grades, the total number may be set as X=3*3*3=9 times. If each of the intensity grades is defined as a grade range from one grade to five grades, the total number may be set as X=5*5*5=125 times.

In step S23, the arm control module 102 controls the probe 50 of the test fixture 5 to be plugged into one of the SAS ports 20 using the mechanical arm 4. In the embodiment, the arm control module 102 generates a command to drive the mechanical arm 4 to control the probe 50 of the test fixture 5 to be plugged into the SAS port 20 to be tested.

In step S24, the signal measuring module 103 adjusts the signal intensity grade through the SAS port 20, and controls the SAS port 20 to generate a SAS signal corresponding to the signal intensity grade. In one embodiment, the signal measuring module 102 enhances the SAS signal by increasing the intensity grade of the SAS signal, and weakens the SAS signal by decreasing the intensity grade of the SAS signal.

In step S25, the signal measuring module 103 obtains the SAS signal generated by the SAS ports 20 using the test fixture 5, and measures a value of the test parameter of the SAS signal using the oscilloscope 3.

In step S26, the signal measuring module 103 records the measured values of the test parameters into a predefined file, such as an EXECL format file, and increases a test number (denoted as “Y”) by one, i.e., Y=Y+1, when the values of the test parameters are recorded into the predefined file.

In step S27, the signal measuring module 103 determines whether the test number is equal to the total number. If the test number is not equal to the total number, step S24 is repeated. Otherwise, if the test number is equal to the total number, step S28 is implemented.

In step S28, the signal analyzing module 104 analyzes the value of the test parameters to find an optimal SAS signal, and ascertains an intensity grade of the optimal SAS signal as a driving parameter of the SAS port 20. In the embodiment, the optimal SAS signal has a minimum jitter value or a minimum phase value.

In step S29, the signal analyzing module 104 determines whether all of the SAS ports 20 have been tested. If all of the SAS ports 20 have not been tested, step S23 is repeated. Otherwise, if all of the SAS ports 20 have been tested, step S30 is implemented.

In step S30, the signal analyzing module 104 generates a test report of the SAS ports 20 according to the measured values of the test parameters, and stores the test report of the SAS ports 20 into the storage system 12.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, the computing device connected to a server having a plurality of serial attached SCSI (SAS) ports, an oscilloscope, and a mechanical arm that is equipped with a test fixture, the computing device comprising:
a storage system;
at least one processor; and
one or more programs stored in the storage system and executable by the at least one processor, the one or more programs comprising:
a parameter setting module that sets a group of test parameters for evaluating integrity of SAS signals, and sets an intensity grade of the SAS signals and a total number for testing the SAS ports of the server;
an arm control module that controls a probe of the test fixture to be plugged into one of the SAS ports using the mechanical arm;
a signal measuring module that adjusts the intensity grade of the SAS signals through the SAS port, controls the SAS port to generate a SAS signal corresponding to the intensity grade, obtains the SAS signal generated by the SAS port using the test fixture, and measures a value of each of the test parameters of the SAS signal using the oscilloscope; and
a signal analyzing module that analyzes the measured value of each of the test parameters to find an optimal SAS signal, determines an intensity grade of the optimal SAS signal as a driving parameter of the SAS port, and generates a test report of the SAS port according to the measured values of the test parameters.

2. The computing device according to claim 1, wherein the computing device electronically connects to the server through a serial port, and connects to the oscilloscope through a first general purpose interface bus (GPIB), and the test fixture connects to the oscilloscope through a second GPIB.

3. The computing device according to claim 1, wherein the signal measuring module further records the measured values of the test parameters into a predefined file, and increases a test number by one when the measured values of the test parameters are recorded into the predefined file.

4. The computing device according to claim 3, wherein the signal measuring module further determines whether the test number is equal to the total number, and continues to adjust the intensity grade of the SAS signal for measuring the test parameters of the SAS signal until the test number is equal to the total number.

5. The computing device according to claim 1, wherein the signal analyzing module further determines whether all of the SAS ports have been tested, and the arm control module further controls the probe of the test fixture to be plugged into a next SAS port of the server using the mechanical arm until all of the SAS ports have been tested.

6. The computing device according to claim 1, wherein the test parameters comprise a phase value, a jitter value, a period value, a frequency value, a rising time and a falling time of the SAS signal.

7. A method for testing serial attached SCSI (SAS) ports of a server using a computing device, the computing device connected to an oscilloscope and a mechanical arm that is equipped with a test fixture, the method comprising steps of:
setting a group of test parameters for evaluating integrity of SAS signals, and setting an intensity grade of the SAS signals and a total number for testing the SAS ports;
controlling a probe of the test fixture to be plugged into one of the SAS ports using the mechanical arm;
adjusting the intensity grade of the SAS signals through the SAS port, and controlling the SAS port to generate a SAS signal corresponding to the intensity grade;
obtaining the SAS signal generated by the SAS port using the test fixture, and measuring a value of each of the test parameters of the SAS signal using the oscilloscope;
analyzing the measured value of each of the test parameters to find an optimal SAS signal;
ascertaining an intensity grade of the optimal SAS signal as a driving parameter of the SAS port; and
generating a test report of the SAS port according to the measured values of the test parameters.

8. The method according to claim 7, wherein the computing device connects to the server through a serial port, and connects to the oscilloscope through a first general purpose interface bus (GPIB), and the test fixture connects to the oscilloscope through a second GPIB.

9. The method according to claim 7, further comprising:
recording the measured values of the test parameters into a predefined file; and
increasing a test number by one when the measured values of the test parameters are recorded into the predefined file.

10. The method according to claim 9, further comprising:
determining whether the test number is equal to the total number; and
repeating from the adjusting step to the ascertaining step until the test number is equal to the total number.

11. The method according to claim 7, further comprising:
determining whether all of the SAS ports have been tested; and
repeating from the controlling step to the ascertaining step until all of the SAS ports have been tested.

12. The method according to claim 7, wherein the test parameters comprise a phase value, a jitter value, a period value, a frequency value, a rising time and a falling time of the SAS signal.

13. A non-transitory computer-readable storage medium having stored thereon instructions that, when executed by at least one processor of a computing device, causes the computing device to perform a method for testing serial attached SCSI (SAS) ports of a server, the computing device connected to an oscilloscope and a mechanical arm that is equipped with a test fixture, the method comprising steps of:
setting a group of test parameters for evaluating integrity of SAS signals, and setting an intensity grade of the SAS signals and a total number for testing the SAS ports;
controlling a probe of the test fixture to be plugged into one of the SAS ports using the mechanical arm;
adjusting the intensity grade of the SAS signals through the SAS port, and controlling the SAS port to generate a SAS signal corresponding to the intensity grade;
obtaining the SAS signal generated by the SAS port using the test fixture, and measuring a value of each of the test parameters of the SAS signal using the oscilloscope;
analyzing the measured value of each of the test parameters to find an optimal SAS signal;
ascertaining an intensity grade of the optimal SAS signal as a driving parameter of the SAS port; and
generating a test report of the SAS port according to the measured values of the test parameters.

14. The storage medium according to claim 13, wherein the computing device connects to the server through a serial port, and connects to the oscilloscope through a first general purpose interface bus (GPIB), and the test fixture connects to the oscilloscope through a second GPIB.

15. The storage medium according to claim 13, wherein the method further comprises:
recording the measured values of the test parameters into a predefined file; and
increasing a test number by one when the measured values of the test parameters are recorded into the predefined file.

16. The storage medium according to claim 15, wherein the method further comprises:
determining whether the test number is equal to the total number; and
repeating from the adjusting step to the ascertaining step until the test number is equal to the total number.

17. The storage medium according to claim 13, wherein the method further comprises:
determining whether all of the SAS ports have been tested; and
repeating from the controlling step to the ascertaining step until all of the SAS ports have been tested.

18. The storage medium according to claim 13, wherein the test parameters comprise a phase value, a jitter value, a period value, a frequency value, a rising time and a falling time of the SAS signal.
